(19) United States
(12) Patent Application Publication
(10) Pub. No.: US 2022/0292055 A1
(43) Pub. Date: Sep. 15, 2022

(54) DATA EXPANSE VIEW MECHANISM

(71) Applicants: Michael J. Rieschl, Eagan, MN (US); David Schroth, Eagan, MN (US); Matthew Trautman, Eagan, MN (US); Charles R. Caldarale, Eagan, MN (US)

(72) Inventors: Michael J. Rieschl, Eagan, MN (US); David Schroth, Eagan, MN (US); Matthew Trautman, Eagan, MN (US); Charles R. Caldarale, Eagan, MN (US)

(73) Assignee: Unisys Corporation, Blue Bell, PA (US)

(21) Appl. No.: 17/199,541

(22) Filed: Mar. 12, 2021

(51) Int. Cl. G06F 16/11

(52) U.S. Cl. CPC G06F 16/122

(57) ABSTRACT

A computing system includes a database, an operating system and a database management system. The computing system also includes an instruction processor in communication with the database management system; the database management system having a bank, a RDMS data expanse and a view mechanism; the operating system having a data expanse view control in communication with the hank and a data expanse view control in communication with the RDMS data expanse; wherein the database management system can request a data expanse file be created at the operating system and can request a view of the data expanse file using a view instruction from the instruction processor. A method of calling a view of database files includes receiving a user instruction from an instruction processor to create a view of database files in a data management system; sending the user instruction to an operating system, causing the operating system to create a data expanse and return the data expanse address to the database management system; and creating a view of the database expanse for the user to view a subset of the data expanse.

### FIELD OF THE DISCLOSURE

The instant disclosure relates generally to database systems. More specifically, this disclosure relates to a database system that includes a data expanse viewer and a view instruction.

### BACKGROUND

Database management systems traditionally provide for the management of data in a particular database and the management of access to that data by many different user programs. The user programs are often written in a high level language, such as C, C++, Java, or some other analogous language. The user program typically performs a call of the database management system when a database operation is to be performed.

Conventional database management systems have numerous drawbacks. For example, conventional systems require the caching of data in the database management system, which requires the database management system to manage data control using locks and test & set operations on the underlying data file. Beyond the cache control requirement, conventional database management systems are required to address various portions of database files to access data managed by the database, and often times the addressable range of the database management system is smaller than the maximum size of database files. Thus, the requirement that the database management system address data from database files becomes a hindrance to conventional database management systems because it limits the size of the database files that can be managed, or at the very least limits a user application to addressing only data that is located in a particular range of addresses. As database file sizes continue to increase, the issues associated with conventional database management systems will only become more problematic.

### SUMMARY

The accessing of database files may be improved with systems and methods that provide data expanse views of memory-mapped files on certain operating systems, including SAIL-based operating systems. According to one embodiment, a computing system includes a database, an operating system and a database management system. The computing system also includes an instruction processor in communication with the database management system; the database management system having a bank, a RDMS data expanse and a view mechanism; the operating system haying a data expanse view control in communication with the bank and a data expanse view control in communication with the RDMS data expanse; wherein the database management system can request a data expanse file be created at the operating system and can request a view of the data expanse file using a view instruction from the instruction processor.

According to another embodiment, a method of calling a view of database files is disclosed. The method including receiving a user instruction from an instruction processor to create a view of database files in a data management system; sending the user instruction to an operating system, causing the operating system to create a data expanse and return the data expanse address to the database management system; and creating a view of the database expanse for the user to view a subset of the data expanse.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the concepts and specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed systems and methods, reference is now made to the following descriptions taken in conjunction with the accompanying drawings:

FIG. 1A is a first schematic diagram illustrating a computing system including a database management system, according to one example embodiment of the present disclosure;

FIG. 1B is a second schematic diagram illustrating a computing system including a database management system, according to one example embodiment of the present disclosure;

FIG. 2 is a schematic view illustrating a user application interface to a database management system and the handling of analytic queries at the database management system, according to one example embodiment of the present disclosure;

FIG. 3 is a schematic diagram illustrating a computing system including a database management system, according to one example embodiment of the present disclosure;

FIG. 4 is a state diagram illustrating operations of the computing system, according to one example embodiment of the present disclosure;

FIG. 5 is a flow diagram illustrating a VIEW algorithm, according to one example embodiment of the present disclosure;

FIG. 6 is a block diagram illustrating a computer network, according to one example embodiment of the present disclosure;

FIG. 7 is a block diagram illustrating a computer system, according to one example embodiment of the present disclosure;

FIG. 8A is a block diagram illustrating a server hosting an emulated software environment for virtualization, according to one example embodiment of the present disclosure; and

FIG. 8B is a block diagram illustrating a server hosting an emulated hardware environment, according to one example embodiment of the present disclosure;

### DETAILED DESCRIPTION

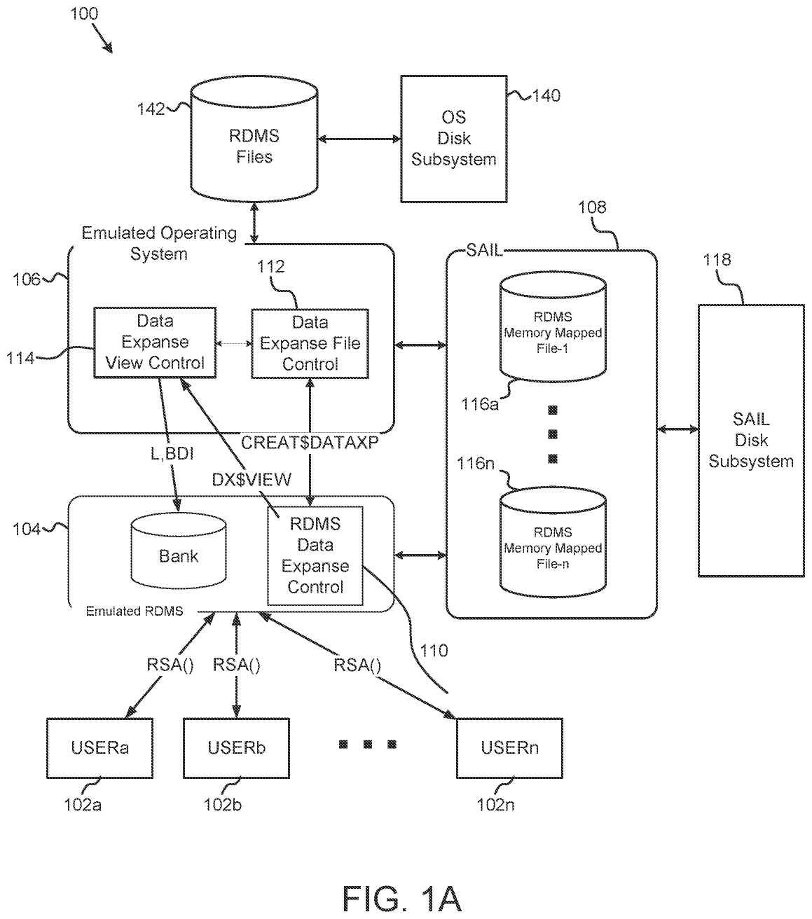

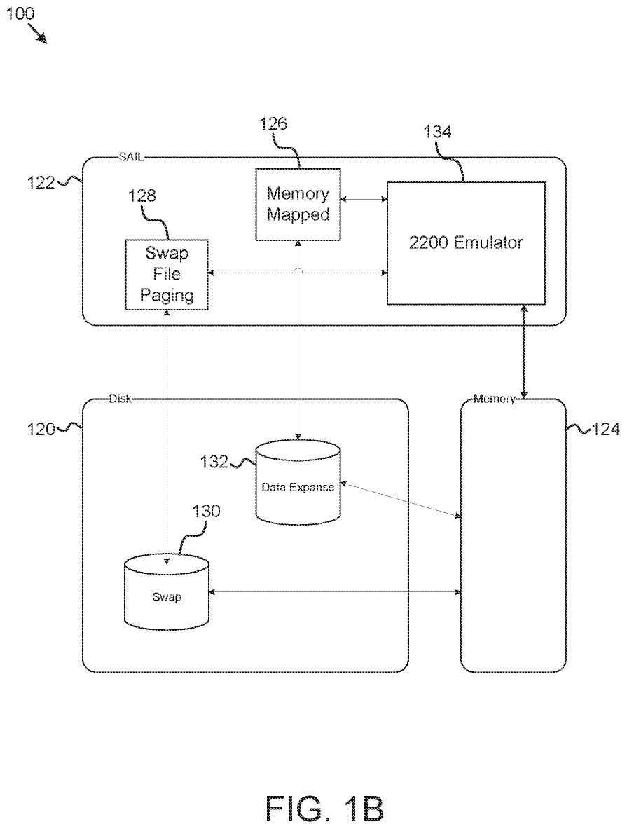

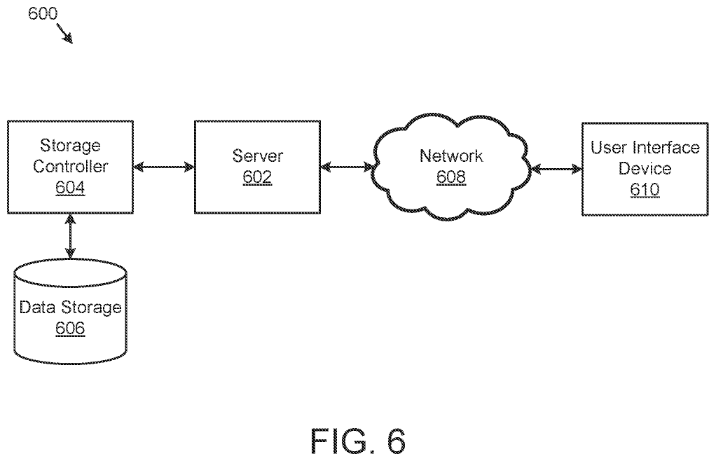

FIG. 1A provides an illustration of a computing system including a database management system according to one embodiment of the disclosure. In system 100, the instruction set of the computing system may be emulated or translated, via software, executing on an underlying instruction set and operating system, such as from a commodity instruction processor, such as the x86 processor, and Linux. As shown, the system 100 may include a plurality of user applications 102a-n communicatively coupled to a database management system 104, in some embodiments, one or more query statements may be received by the database management system (DMS) 104 from the plurality of user applications 102a-n. The database management system 104 may analyze the query statement to determine if there are any errors in the statement itself The user applications 102a-n can be located, for example, on the same computing device as the database management system 104 or on a different computing device of devices that are communicatively connected thereto. Examples of computing devices useable to execute computing instructions constituting the user applications 102a-n and the database management system 104 are discussed below in connection with FIGS. 6-8.

In the embodiment shown in FIG. 1A, the database management system 104 may be a relational database management system (RDMS) configured to receive and process SQL commands from the plurality of user applications 102a-n to perform operations on database files. The database management system 104 may be configured to access an emulated operating system 106. The emulated operating system 106, which may be, for example, Linux, Windows, Java, Unix, OS 2200, or the like, may execute on a server, controlled by SAIL 108, and include drivers for accessing hardware components. The emulated operating system 106 may be configured to access an OS disk subsystem 140 to store database files, such as RDMS files 142, at the OS disk subsystem 140 or to retrieve database files 142 from the OS disk subsystem 140. According to some embodiments, the database files 142 may be physically stored at the OS disk subsystem 140. The emulated operating system 106 may access the OS disk subsystem 140 to provide access to one or more database files 142 to the database management system 104, the plurality of user applications 102a-n, and an interface 108.

An interface 108, such as SAIL 108, may provide an interface between the emulated operating system 106 executing on a server and an operating environment, such as Linux, thereby providing the underlying operating system on which an operating environment executes. In some embodiments, SAIL 108 may include the emulated operating system 106 and the layer in which the operating environment executes, such as Linux. In some embodiments, SAIL 108 may be responsible for loading and initializing in processor emulators in the computer system 100. According to another embodiment, SAIL 108 may also acquire and initialize the initial memory area used by an operating environment and pass a pointer to the initial memory area to instruction processor emulators during a computer system startup.

The SAIL 108 may also interface with SAIL disk subsystem 118, which may physically store memory-mapped data expanse files 116a-n, to provide access to one or more memory-mapped data expanse tiles 116a-n to the emulated operating system 106 the database management system 104, and the plurality of user applications 102a-n. For example, in some embodiments, one or more database files 142 retrieved by the emulated operating system 106 from the OS disk subsystem 140 may be mapped to one: or more memory-mapped data expanse files 116a-n located at the SAIL 108 and stored at the SAIL disk subsystem 118. As shown in FIG. 1A, a plurality of memory-mapped data expanse files 116 may be located at the operating system interface 108, and each memory-mapped data expanse file 116a-n of the plurality of memory-mapped data expanse files 116 may represent a different mapping to a different database file 142. The SAIL 108 may transmit addresses representing the created data expanses 116a-n to the emulated operating system 106, and the addresses may be utilized by the database management system 104 and the plurality of user applications 106a-n to access data in the database tiles 142 via the data expanses 116a-n located at the SAIL 108.

The emulated operating system 106 can be any of a variety of operating systems capable of hosting a database management system 104 and which provides access controls to data stored in database tiles 142 on the OS disk subsystem 140. In one example embodiment, the emulated operating system 106 can be an operating system from Unisys Corporation of Blue Bell, Pa. In alternative embodiments, other operating systems could be used as well.

In the embodiment shown in FIG. 1A, the database management system 104 includes the RDMS a data expanse control 110. The data expanse control manages the creation of a memory-mapped data expanses and view requests for data stored in various memory-mapped data expanses that are managed by the SAIL 108. Cooperatively, the emulated operating system 106 includes a data expanse file control component 112 and a data expanse view control component 114. In some embodiments, the RDMS data expanse control 110 can transmit a request to the emulated operating system 106, in the form of a call to the data expanse file control component 112 to create a data expanse defined by the attributes of a database file (shown as the call CREAT$DATAXP), This call may tell the emulated operating system 106 to call an acquire function associated with the SAIL 108 or 122 to create the memory mapped data expanse file. Once the memory-mapped data expanse is initialized, by transferring data from the RDMS Files 142 to the RDMS Memory Mapped file 116, the database management system 104 is returned the address call-back into the emulated operating system 106 to manage the memory-mapped data expanse.

Following creation of the memory-mapped data expanse, the data expanse control 110 can be used by any of the user applications 102a-n to access and/or modify data in the memory-mapped data expanse by creating a view of the data expanse. In one embodiment, the data expanse may be the memory mapped data expanse created by the CREAT$DATAXP call. The data expanse view may be a bank created by the operating system 106 in response to a DX$VIEW. The bank may be a visible subset or view of the data expanse. For example, each of the user applications can request a different view of the data expanse, defined by a starting address (i.e., an offset from the starting address returned to the RDMS data expanse control 110), as well as a size of the view to be created. This can be accomplished, for example as shown, using the operating system call DX$VIEW, providing the starting address and size of the view to be created. The data expanse view control component 114 can then create a view of the data expanse, and provide to the database management system 104 a private address of the view. For example, the address can be an extended virtual mode address, including a length and a bank descriptor index to reference the location of the view.

In some embodiments, the data expanse may be referenced by its starting address or by an address of a particular segment, therefore the RDMS data expanse control 110 and other portions of the database management system 104 may not need to be capable of addressing the entire range of the data expanse created. Rather, the particular view created within the data expanse may be fully addressable by the database management system 104. In this way, a database management system, such as system 104, can be made compatible with data files having sizes greater than a maximum addressable range of the database management system. For example, in some embodiments of the present disclosure, the database management system 104 may be capable of individually addressing addresses in a bank of 262 thousand words; in such an arrangement, the database file 142 can have a size in excess of that number, since the address identified by the database management system to the emulated operating system 106 might identify an offset on a bank-by-bank basis, rather than on an individual, word-addressable basis.

Furthermore, using the system 100 as illustrated, a bank may be made accessible to the database management system 104 without requiring that the database management system cache each database file. Still further, and in contrast to locking a bank (and corresponding database file) to a particular application, the data expanse arrangement of FIG. 1A may allow a database file to be individually accessed by many different user applications 102a-n concurrently. By providing a private view into a publicly accessible database file the database management system 104 and emulated operating system 106 may alleviate many possible data conflicts. Additional information regarding data expanses is provided in U.S. Patent Application Publication No. 2014/0149459 entitled “Data expanse viewer for database systems,” which is hereby incorporated by reference.

FIG. 1B provides another illustration of a computing system including a database management system according to one embodiment of the disclosure. In particular, FIG. 1B illustrates the coexistence of both swapped and memory-mapped files in a computing system. In general, a swap file may allow an operating system to use hard disk space to simulate extra memory. For example, when the system runs low on memory, the system may swap a section of RAM that an idle program is using onto the hard disk to free up memory for other programs. When the system subsequently accesses the swapped out program, the swapped out program on the hard disk may change places with another program in RAM.

The aforementioned combination of RAM and swap files may be viewed as one interpretation of virtual memory. The use of virtual memory may allow a computing system to run more programs than it could run in RAM alone. In some embodiments, an operating system, such as Linux, Windows, Java, Unix, or the like, may set aside a permanent swap space that reserves a certain portion of the hard disk. According to one embodiment, permanent swap files may take a contiguous section of the hard disk.

A memory-mapped file may be a segment of virtual memory which has been assigned a direct byte-for-byte correlation with some portion of a file or file-like resource. This resource may be a file that is physically present on-disk or may be a device, shared memory object, or other resource that the operating system can reference through a file descriptor. Once present, the correlation between the file and the memory space may permit applications to treat the mapped portion as if it were primary memory. One benefit of Memory mapping a tile is increased input/output (I/O) per for example, when files being accessed are large. Therefore, in some embodiments, implementing a data expanse with memory mapped files instead of swap files may lead to increased system performance.

Referring to FIG. 1B, the computing system may include a disk 120, a SAIL 122, and a memory 124 In some embodiments, the disk 120 may be a disk within an RDMS, and the memory 124 may be RAM. Other embodiments of the computing system are discussed below in connection with. FIGS. 6-8. As shown in the embodiment of FIG. 1B, the SAIL 122 may include a memory mapping interface 126 that can assign and delete memory-mapped files. The SAIL 122 may also include a swap file paging interface 128 that can assign, delete, and/or recover operating system memory and other virtual space used by the computing system 100. The disk 120 may include a swap file 130 and a data expanse composed of memory mapped files 132. Although FIG. 1B illustrates the swap file 130 and the data expanse (memory mapped files) 132 both being on the same disk 120, in some embodiments, the swap file 130 and the data expanse (memory mapped files) 132 may be located on separate disks.

According to an embodiment, paging by the SAIL 122 may move data in and out of memory 124 from the swap tale 130 and the data expanse (memory mapped files) 132. In some embodiments, an emulator 134 within the SAIL 122 may reference data directly into memory 124 using a virtual address assigned by either the swap file paging interface 128 or the memory mapping interface 126. For example, when an operating system needs memory for banks the operating system may call the swap file paging interface 128 to allocate the required memory and return a virtual address to the allocated memory. The allocated memory may be part of a swap space and may be shared with other applications executing in SAIL 122, such as network I/O. When a bank is no longer needed, a call may be made by the operating system to remove and recycle the memory space. According to another embodiment, when the operating system needs to assign a data expanse, the operating system may call the memory mapping interface 126 to initialize a memory mapped file and return a virtual address to the file.

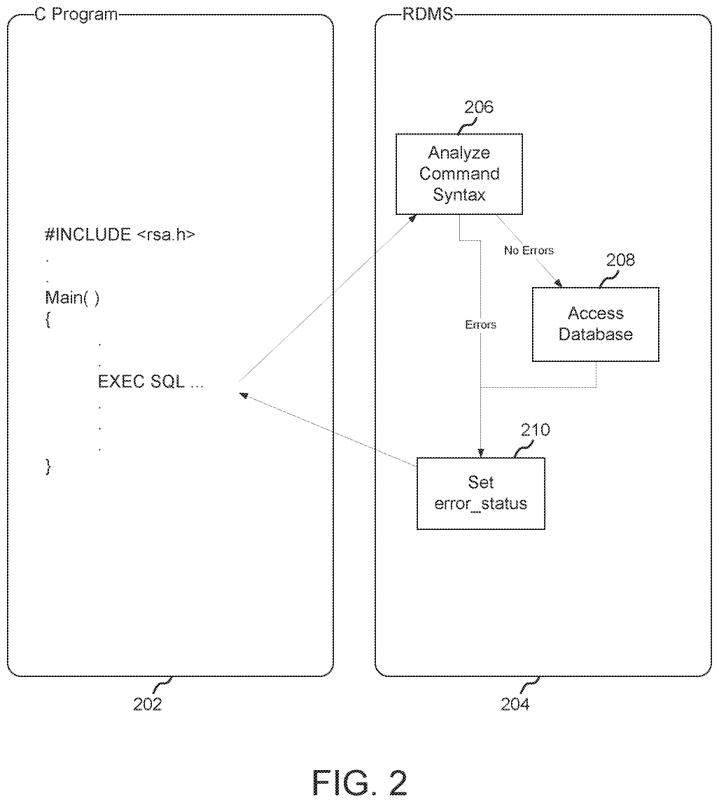

FIG. 2 illustrates a user application interface to a database management system and the handling of analytic queries at the database management system according to one embodiment of the disclosure. In the embodiment shown, a user application 202 includes code, which can be written, for example, in C (as shown), or any of a variety of other types of programming languages, such as C++, Java, or other languages. RDMS users use Structured Query Language (SQL) to create and access the RDMS database. SQL commands let an application program retrieve, delete, insert and update data in a relational database. The user application 202 may include a call to a database management program 204 within the code of the application, to effect access to a database, e.g., to read or edit data in the database managed by the database management program 204. In the example embodiment shown, the user application 202 includes a line of code in the C programming language indicated as “EXEC SQL . . . ” which may represent a form of a line of code useable to call the database management program 204. In various embodiments, the user application 202 can be any of a variety of user applications useable to access and/or modify data in a database.

The database management program 204 can be any program implementing a database management system that is hosted by an underlying operating system. In an example embodiment, the database management program may correspond to a relational database management system such as the relational database management system (RDMS) available from Unisys Corporation of Blue Bell, Pa. The relational data model represents data in two dimensional tables of rows and columns. In alternative embodiments, other types of database management systems, and other arrangements of databases, could be used as well.

In the embodiment shown, the database management program 204 may include a syntax analyzer component 206, an access component 208, and an error status component 210. The components 206-210 may be used to access and validate access requests to data on behalf of the user application 202 by the database management program 204. The syntax analyzer component 206 may receive a database command from the user application 202, such as a SQL command, or other database command that will allow the application program to add, delete, insert, and update data in a database. In some embodiments, the syntax analyzer component 206 may determine an operation to be performed based on parsing of the received command.

If no errors are detected in the command, the access component 208 may interface with an underlying operating system to access a file containing data associated with the database accessed by the user application 202 for parsing and use by the database management program 204. The access component 208 can then execute the database command as defined in the received command. In such a case, an error status component 210 may be set to indicate that no error has occurred in completion of the database operation. However, if an error is detected in the syntax analyzer component 206, or during performance of the command by the access component 208, error status component 210 may indicate that an error exists in the received database command. Accordingly, either a confirmation of the properly executed database command, or an indication of an error, can be returned from the error status component 210 to the user application 202.

In some embodiments, beyond passage of particular database commands from the user application 202, it is also possible for the database management program 204 to allow use of placeholder variables in a command string, and therefore transfer values from program variables in the C code of the program to the database, or from the database to program variables in the C code, thereby integrating the database as a mechanism for storage of large program constructs, such as variables of large size, variable classes, and other data structures used as variables and for which storage in a database is convenient.

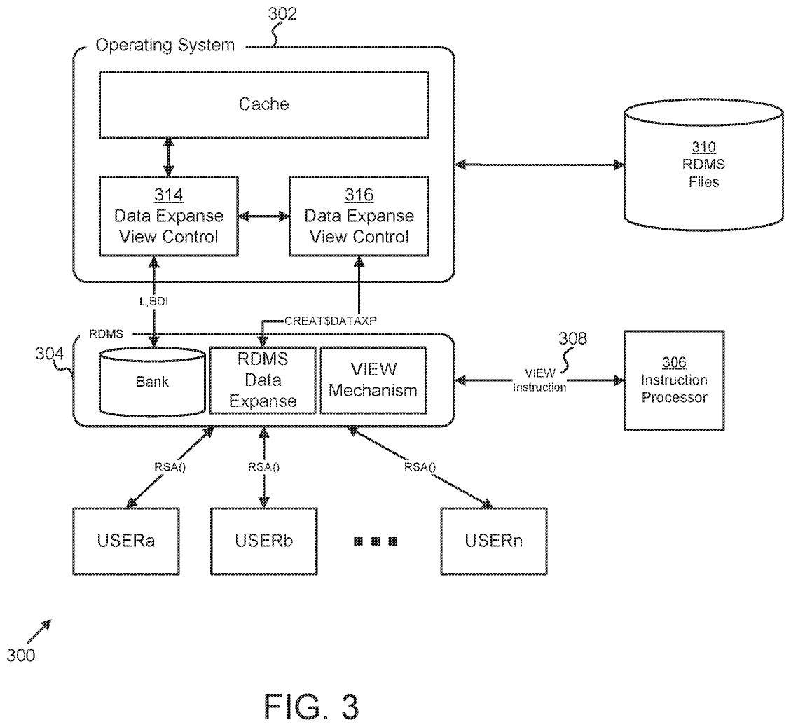

In one example embodiment, FIG. 3 illustrates an RDMS implementation 300. A performance increase is obtained by creating a data expanse at the operating system 302 level and allowing the RDMS subsystem 304 to request views of the data by using an instruction processor 306 and its VIEW instruction 308. The user's program SQL statement is analyzed. The RDMS 304 accesses the database 310 by calling the mainframe operating system 302 and the VIEW instruction 308.

A CREAT$DATAXP 312 call from the RDMS 304 to the operating 302 tells the operating system to create and initialize all necessary control structures to control the data expanse. A data expanse is a single bank descriptor that allows access to up to 2**60 words of virtual and/or physical space. These control structures include a data expanse view control 314 and a data expanse file control 316. The address of the data expanse is returned in the CREAT$DATAXP packet. The RDMS 304 calls the VIEW instruction 308 and provides the data expanse address, starting offset and size of the postern (can be upto 2**60 words of space), or activity level bank, to be created. The operating system 302 returns the address of the postern (L, BDI) 314 to the RDMS 304. The RDMS 304 bases the postern and the data can be read or written.

The RDMS 304 can modify the postern by calling the VIEW instruction 308, providing the data expanse address, the postern address, starting, offset and the size of the view. The RDMS 304 will base the postern and the data can be read or written. The RDMS 304 can deleted the postern by calling the VIEW instruction 308, providing the data expanse address and a null postern address. The RDMS 304 can delete the expanse by calling a DELET$DATAXP call to the operating system 302.

The above example embodiment is faster than previous implementations because an operating system interface has thousands of instructions to be implemented. Creating the data expanse at the operating system 302 level eliminates the need for an interface. The database can have multiple views enabled at one time.

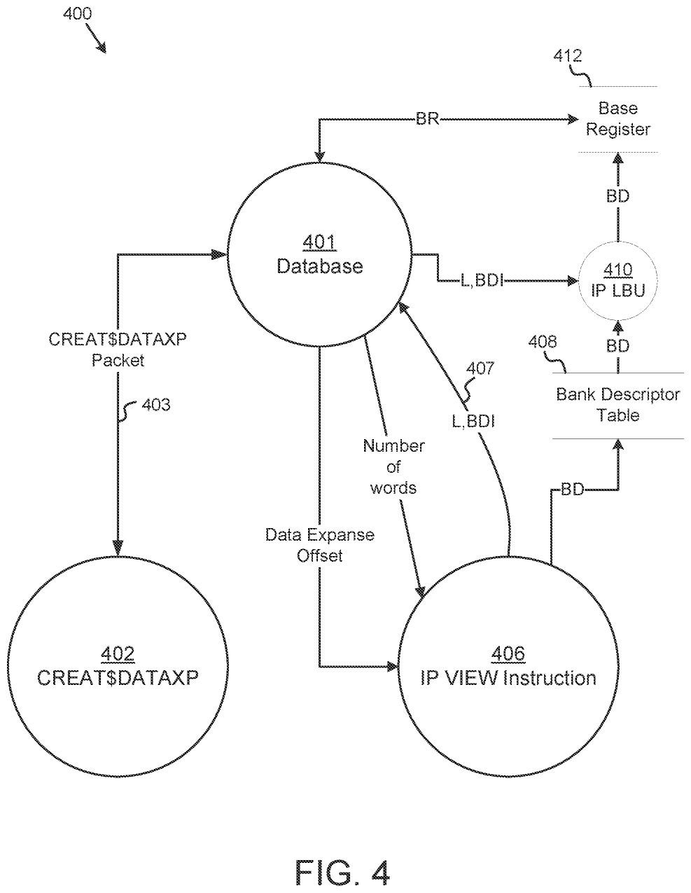

FIG. 4 illustrates the data flow mode for a data expanse implementation, such as that described above for FIG. 3. In the data flow diagram 400, the RUMS requests that the operating system create a data expanse 401 by the CREAT$DATAXP call at state 402. The CREAT$DATAXP call returns 403 the address of the data expanse in the CREAT$DATAXP packet 403. The RDMS calls the VIEW instruction 406 with the data expanse offset, number of words and DEL, DEBDI. If there are no errors, the corresponding bank address 407 of the postern is returned. The RDMS could also modify an existing postern. The RDMS loads the bank (load bank type instruction) on a base register and can now access the data to be read or modified.

The View instruction 406 modifies the Postern BD specified by a U.L., BDI with information from both (U) and from the Data_Expanse BD entry specified by U.DEL,DEBDI and, optionally loads one of the user Base_Registers B2-B15, specified by U.B., to describe a portion of the Data_Expanse entry selected.

Word 0 Bits 0-2 L,BDI

L,BDI selects the Level and BDI of the Postern.

If L,BDI=0 and DEL,DEBDI≠0 then an SSF=3 interrupt is intercepted by the operating system and a postern bank is created. The postern bank's L,BDI is inserted into the packet and the view instruction restarts following the contingency.

Word 0 Bits 18-35

Reserved

Word 1 Bits 0-2 DEL,DEBDI

DEL,DEBDI selects the Level and BDI of the Data Expanse.

If L,BDI≠0 and DEL,DEBDI=0 then an SSF=3 interrupt is intercepted by the operating system and the postern bank is deleted. L,BDI is set to zero in the packet and the next instruction is executed following the contingency.

Word 1 Bits 18-35

Reserved

Word 2 Bits 0-5

Reserved

Word 2 Bits 6-35 Subset

Subset, 30 most significant bits. The Postern BD describes a space starting subset distance from the beginning of the space defined by the selected Data_Expanse BD.

Word 3 Bits 0-35 Subset

Subset, 36 least significant bits. The Postern BD describes a space starting subset distance from the beginning of the space defined by the selected Data_Expanse BD.

Word 4 Bits 0-2

Reserved

Word 4 Bits 3-35 Postern_upper_limit

Postern_upper_limit. The Postern_upper_limit is the highest numbered address from the Postern. BD Base_Address to which the Postern BD has visibility. If Postern_upper_limit>0777776, then hardware generates an Addressing_Exception interrupt (see VIEWing; section 11; step 12).

Word 5 Bits 0- 17

Must Be Zero

Word 5 Bits 18-35 Postern_lower_limit

Postern_lower_limit. When establishing a BD for use by Basic_Mode programs, a non-zero Postern_lower_limit may be required.

Word 6 Bits 0-31

Must_Be_Zero

Word 6 Bits 32-35 B

Base_Register to load. To save having to execute a VIEW then an LBU of the same Postern, the VIEW instruction loads the specified Base_Register B≠0. If B=0, the VIEW instruction does not load a Base_Register from the established Postern BD. If B=1, then hardware generates an Addressing_Exception interrupt (See VIEWing; section 11; step 14).

Word 7 Bits 0-35 Status

Set to zero by user and filled in by operating system if an interrupt (section 13) caused a user error.

All of the interrupts (class9, SSF interrupts) generated from the view instruction hardware are fielded by the operating system and transformed into a user-friendly status that is placed into word 7 of the view operand above. But two interrupts in the view operand are not transformed into a word, but instead cause the operating system to either create a postern or deleted the specified postern. If the postern is created, the operating system fills in the L, BDI the postern and restarts the instruction, If the postern is deleted, the L,BDI is removed from the View operand, a “user” status is stored, and the next instruction is executed. These interrupts include:

Word 0 Bits 0-2 L,BDI

LBDI selects the Level and BDI of the Postern.

If L,BDI=0 and DEL,DEBDI≠0 then an SSF=3 interrupt is intercepted by the operating system and a postern bank is created. The postern bank's L,BDI is inserted into the packet and the view instruction restarts following the contingency.

Word 0 Bits 18-35

Reserved

Word 1 Bits 0-2 DEL,DEBDI

DEL,DEBDI selects the Level and BDI of the Data Expanse.

If L,BDI≠0 and DEL,DEBDI=0 then an SSF=3 interrupt is intercepted by the operating system and the postern bank is deleted. L,BDI is set to zero in the packet and the next instruction is executed following the contingency.

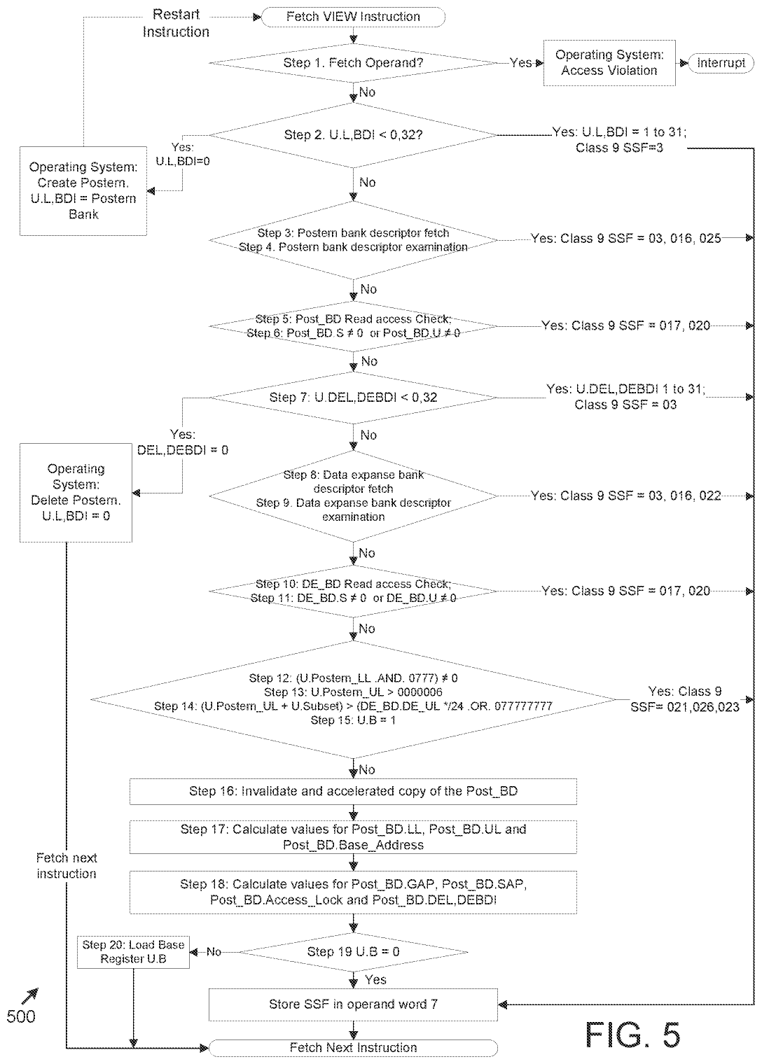

VIEWing is a mechanism whereby a Postern Bank Descriptor (and optionally a Base Register 412) is loaded to describe only a portion of a Data Expanse Bank Descriptor. The VIEW instruction uses a specified Subset, such that subsequent references to that Postern Bank Descriptor interpret U as relative to the Subset rather than to the true start of the Data Expanse, The VIEW instruction also provides Postern upper limit, and Postern lower limit to establish a Postern BD for Basic Mode. VIEWing applies only to Postern Bank Descriptors (and optionally a Base Register). The VIEW Algorithm is as follows and is represented in FIG. 5:

| 1 | The 8-word operand at U is fetched from storage (never from GRS even when U < 0200). If there | |
|---|---|---|
| | are any access violations, generate a Reference_Violation interrupt and exit algorithm. | |
| 2 | Valid L,BDI Check: If U.L,BDI < 0,32, generate an Addressing_Exception interrupt (Class 9, SSF=03) | |
| | and exit algorithm. | |
| 3 | Postern Bank_Descriptor Fetch. The Post_BD described by U.L,BDI is fetched as follows: | |
| | a. | Bank_Descriptor_Table_Pointer (BDTP) selection is made by using B = 16 + L. |
| | b. | An offset is constructed by multiplying BDI by 8. |
| | c. | If the BD offset formed is not within the limits of the selected BDTP, generate an |
| | | Addressing_Exception interrupt (Class 9, SSF=03) and exit algorithm. |
| | d. | The BD at the calculated offset relative to B is fetched. |
| 4 | Postern Bank_Descriptor examination: | |
| | a. | If Post_BD.G = 1, generate an Addressing_Exception interrupt (Class 9, SSF=025) and exit |
| | | algorithm. |
| | b. | If Post_BD.Type ≠ Postern, generate an Addressing_Exception interrupt (Class 9, |
| | | SSF=016) and exit algorithm. |
| | c. | If Post_BD.INA = 1, generate an Addressing_Exception interrupt (Class 9, SSF=03) and exit |
| | | algorithm. |
| 5 | If the Post_BD read access check fails, generate an Addressing_Exception interrupt (Class 9, | |
| | SSF=017) and exit algorithm. | |
| 6 | If Post_BD.S ≠ 0 or Post_BD.U ≠ 0, generate an Addressing_Exception interrupt (Class 9, SSF=020) | |
| | and exit algorithm. | |
| 7 | Valid DEL,DEBDI Check: If U.DEL,DEBDI < 0,32, generate an Addressing_Exception interrupt (Class | |
| | 9, SSF=03) and exit algorithm. | |
| 8 | Data_Expanse Bank_Descriptor Fetch. The DE_BD described by U,DEL,DEBDI is fetched as | |
| | follows: | |
| | a. | Bank_Descriptor_Table_Pointer (BDTP) selection is made by using B = 16 + DEL. |
| | b. | An offset is constructed by multiplying DEBDI by 8. |
| | c. | If the BD offset formed is not within the limits of the selected BDTP, generate an |
| | | Addressing_Exception interrupt (Class 9, SSF=03) and exit algorithm. |
| | d. | The BD at the calculated offset relative to B is fetched. |
| 9 | Data_Expanse (DE) Bank_Descriptor examination: | |
| | a. | If DE_BD.G = 1, generate an Addressing_Exception interrupt (Class 9, SSF=022) and exit |
| | | algorithm. |
| | b. | If DE_BD.Type ≠ Data_Expanse, generate an Addressing_Exception interrupt (Class 9, |
| | | SSF=016) and exit algorithm. |
| 10 | If the DE_BD read access check fails, generate an Addressing_Exception interrupt (Class | |
| | 9, SSF=017) and exit algorithm. | |
| 11 | If DE_BD.S ≠ 0 or DE_BD.U ≠ 0, generate an Addressing_Exception interrupt (Class 9, SSF=020) | |
| | and exit algorithm | |
| 12 | If (U.Postern_lower_limit .AND, 0777) ≠ 0, generate an Addressin_Exception interrupt (Class 9, | |
| | SSF=021) and exit algorithm. | |
| 13 | if U.Postern_upper_limit > 0777776, generate an Addressing_Exception interrupt (Class 9, SSF = | |
| | 026). | |
| 14 | if (U.Postern_upper_limit + U.Subset) > (DE_BD.DE_Upper_Limit_*/24 .OR. 077777777), generate an | |
| | Addressing_Exception interrupt (Class 9. SSF = 026) and exit algorithm. | |
| 15 | if U.B = 1 (BR1), generate an Addressing_Exception interrupt (Class 9, SSF = 023) and exit | |
| | algorithm. | |
| 16 | Invalidate any accelerated copy of the Post_BD: for Active Base Table (ABT) entries for B2-B15 | |
| | where ABT.L,8DI = U.L,BDI, write ABT.L,BDI := 0,0 (ABT.Offset is Architecturally_Undefined), and | |
| | mark associated B.V := 1. | |
| 17 | Calculate values for Post_BD.Lower_Limit, Post_BD.Upper_Limit, and Post_BD.BaseAddress as | |
| | follows: | |
| | a. | Post_BD.Lower_Limit := U.Postern_lower_limit */−9 |
| | b. | Post_BD.Upper_Limit := U.Postern_upper_limit. |
| | c. | Post_BD.Base_Address := DE_BD.Base_Address + U.Subset − U.Postern_lower_limit |
| | | (unsigned 2's complement arithmetic, overflow and carry discarded). |
| | | Note: Executive software must assign 01000000, or larger for the |
| | | DE_BD.Base_Address so that a small U.Subset and a large U.Postern_lower_limit |
| | | generate a positive number for the Post_BD.Base_Address. |
| 18 | Establish the rest of the Postern Bank_Descriptor as follows: | |
| | a. | Post_BD.GAP := DE_BD.GAP. |
| | b. | Post_BD.SAP := DE_BD.SAP. |
| | c. | Post_BD.Access_Lock := DE_BD.Access_Lock. |
| | d. | Post_BD.DEL,DEBDI := U.DEL,DEBDI. |
| 19 | If U.B = 0, no Base_Register is to be loaded, proceed to step 21. | |
| 20 | Load Base_Register: | |
| | a. | The ABT entry corresponding to the Base_Register (U.B) to be loaded is written to reflect |
| | | the bank selected. The ABT.L,BDI := U.L,BDI and ABT.Offset := 0. |
| | b. | The Base_Register (U.B) is loaded with the Post_BD information |

| | |
|---|---|
| 21 | Exit algorithm. |

In view of exemplary systems shown and described herein, methodologies that may be implemented in accordance with the disclosed subject matter will be better appreciated with reference to various functional block diagrams. While, for purposes of simplicity of explanation, methodologies are shown and described as a series of acts/blocks, it is to be understood and appreciated that the claimed subject matter is not limited by the number or order of blocks, as some blocks may occur in different orders and/or at substantially the same time with other blocks from what is depicted and described herein. Moreover, not all illustrated blocks may be required to implement methodologies described herein. It is to be appreciated that functionality associated with blocks may be implemented by software, hardware, a combination thereof or any other suitable means (e.g. device, system, process, or component). Additionally, it should be further appreciated that methodologies disclosed throughout this specification are capable of being stored on an article of manufacture to facilitate transporting, and transferring such methodologies to various devices. Those skilled in the art will understand and appreciate that a methodology could alternatively be represented as a series of interrelated, states or events, such as in a state diagram.

FIG. 6 illustrates a computer network 600 for obtaining, access to database files in a computing system according to one embodiment of the disclosure. The system 600 may include a server 602, a data storage device 606 a network 608, and a user interface device 610. The server 602 may also be a hypervisor-based system executing one or more guest partitions hosting operating systems with modules having server configuration information. In a further embodiment, the system 600 may include a storage controller 604, or a storage server configured to manage data communications between the data storage device 606 and the server 602 or other components in communication with the network 608. In an alternative embodiment, the storage controller 604 may be coupled to the network 608.

In one embodiment, the user interface device 610 is referred to broadly and is intended to encompass a suitable processor-based device such as a desktop computer, a laptop computer, a personal digital assistant (PDA) or tablet computer, a smartphone or other mobile communication device having access to the network 608. In a further embodiment, the user interface device 610 may access the Internet or other wide area or local area network to access a web application or web service hosted by the server 602 and may provide a user interface for enabling a user to enter or receive information.

The network 608 may facilitate communications of data between the server 602 and the user interface device 610. The network 608 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate.

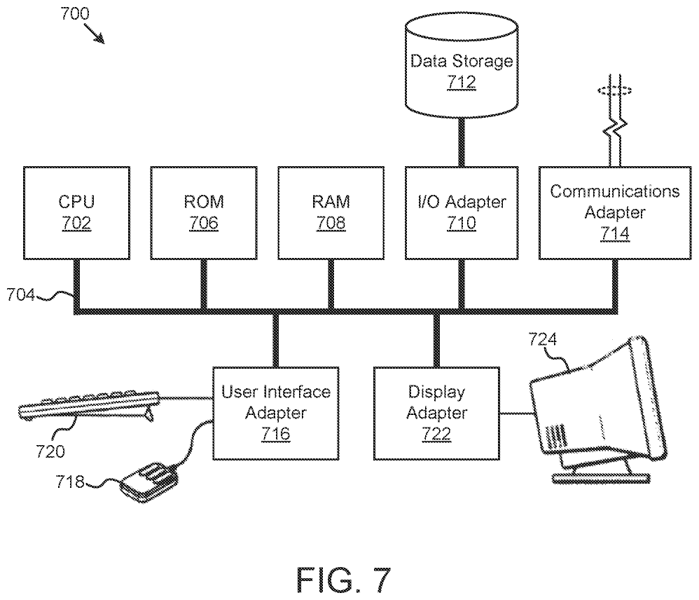

FIG. 7 illustrates a computer system 700 adapted according to certain embodiments of the server 602 and/or the user interface device 610. The central processing unit (“CPU”) 702 is coupled to the system bus 704. The CPU 702 may be a general purpose CPU or microprocessor, graphics processing unit (“GPU”), and/or microcontroller. The present embodiments are not restricted by the architecture of the CPU 702 so long as the CPU 702, whether directly or indirectly, supports the operations as described herein. The CPU 702 may execute the various logical it according to the present embodiments.

The computer system 700 may also include random access memory (RAM) 708, which may be synchronous RAM (SRAM), dynamic RAM (DRAM), synchronous dynamic RAM (SDRAM), or the like. The computer system 700 may utilize RAM 708 to store the various data structures used by a software application. The computer system 700 may also include read only memory (ROM) 706 which may be PROM, EPROM, EEPROM, optical storage, or the like. The ROM may store configuration information for booting the computer system 700. The RAM 708 and the ROM 706 hold user and system data, and both the RAM 708 and the ROM 706 may be randomly accessed.

The computer system 700 may also include an I/O adapter 710, a communications adapter 714, a user interface adapter 716, and a display adapter 722. The I/O adapter 710 and/or the user interface adapter 716 may, in certain embodiments, enable a user to interact with the computer system 700. In a further embodiment, the display adapter 722 may display a graphical user interface (GUI) associated with a software or web-based application on a display device 724, such as a monitor or touch screen.

The I/O adapter 710 may couple one or more storage devices 712, such as one or more of a hard drive, a solid state storage device, a flash drive, a compact disc (CD) drive, a floppy disk drive, and a tape drive, to the computer system 700. According to one embodiment, the data storage 712 may be a separate server coupled to the computer system 700 through a network connection to the I/O adapter 710. The communications adapter 714 may be adapted to couple the computer system 700 to the network 608, which may be one or more of a LAN, WAN, and/or the Internet. The user interface adapter 716 couples user input devices, such as a keyboard 720, a pointing device 718, and/or a touch screen (not shown) to the computer system 700. The display adapter 722 may be driven by the CPU 702 to control the display on the display device 724. Any of the devices 702-722 may be physical and/or logical.

The applications of the present disclosure are not limited to the architecture of computer system 700. Rather the computer system 700 is provided as an example of one type of computing device that may be adapted to perform the functions of the server 602 and/or the user interface device 710. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments. For example, the computer system 700 may be virtualized for access by multiple users and/or applications.

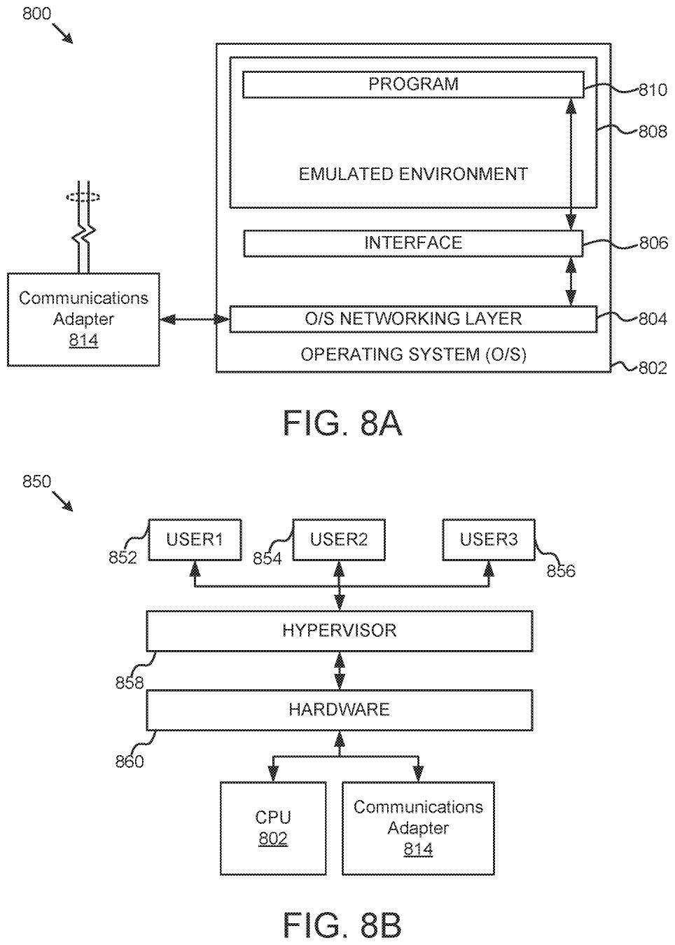

FIG. 8A is a block diagram illustrating a server hosting an emulated software environment for virtualization according to one embodiment of the disclosure. An operating system 802 executing on a server includes drivers for accessing hardware components, such as a networking layer 804 for accessing the communications adapter 814. The operating system 802 may be, for example, Linux or Windows. An emulated environment 808 in the operating system 802 executes a program 810, such as Communications Platform (CPComm) or Communications Platform for Open Systems (CPCommOS). The program 810 accesses the networking layer 804 of the operating system 802 through a non-emulated interface 806, such as extended network input output processor (XNIOP). The non-emulated interface 806 translates requests from the program 810 executing in the emulated environment 808 for the networking layer 804 of the operating system 802.

In another example, hardware in a computer system may be virtualized through a hypervisor. FIG. 8B is a block diagram illustrating a server hosting an emulated hardware environment according to one embodiment of the disclosure. Users 852, 854, 856 may access the hardware 860 through a hypervisor 858. The hypervisor 858 may be integrated with the hardware 860 to provide virtualization of the hardware 860 without an operating system, such as in the configuration illustrated in FIG. 8A. The hypervisor 858 may provide access to the hardware 860, including the CPU 802 and the communications adaptor 814.

If implemented in firmware and/or software, the functions described above may be stored as one or more instructions or code on a computer-readable medium. Examples include non-transitory computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and blu-ray discs. Generally, disks reproduce data magnetically, and discs reproduce data optically. Combinations of the above should also be included within the scope of computer-readable media.

In addition to storage on computer-readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A computing system including a database, an operating system and a database management system, the system comprising:
an instruction processor in communication with the database management system;
the database management system having a bank, a RDMS data expanse and a view mechanism;
the operating system having a data expanse view control in communication with the bank and a data expanse view control in communication with the RDMS data expanse;
wherein the database management system can request a data expanse file be created at the operating system and can request a view of the data expanse file using a view instruction from the instruction processor.

2. The computing system according to claim 1, wherein the data expanse file has a single hank descriptor that allows access to up 2**60 words of virtual or physical space.

3. The computing system according to claim 1, wherein the data expanse file has a data expanse address.

4. The computing system according to claim 3, wherein the database management system can use the view instruction to request a view of the data expanse file by providing the data expanse address, a starting offset and size of a postern to be created.

5. The computing system according to claim 4, wherein the operating, system returns a pastern address to the database management system.

6. The computing system according to claim 5 wherein the database management system bases the postern such that the data can be read or written.

7. The computing system according to claim 6, wherein the database management system can modify the postern by calling the view instruction and providing the data expanse address, the postern address, starting offset and the size of the view.

8. The computing system according claim 6, wherein the database management system can delete the postern by calling the view instruction, providing the data expanse address and a null postern address.

9. A method of calling a view of database files, the method comprising:
receiving a user instruction from an instruction processor to create a view of database files in a data management system;
sending the user instruction to an operating system, causing the operating system to create a data expanse and return the data expanse address to the database management system; and
creating a view of the database expanse for the user to view a subset of the data expanse.

10. The method according to claim 9, wherein causing the operating system to create a data expanse includes creating and initializing all necessary control structures to control the data expanse.

11. The method according to claim 10, Wherein the necessary control structures to control data expanse include a data expanse view control and a data expanse file control.

12. The method according to claim 9, wherein causing includes creating a data expanse file with a single bank descriptor that allows access to up 2**60 words of virtual or physical space.

13. The method according to claim 9, further comprising returning, by the operating system, to the database management system a data expanse address.

14. The method according to claim 13, further comprising calling, by the database management system the view instruction and providing the data expanse address, a starting offset and size of a postern to be created.

15. The method according to claim 14, further comprising returning, by the operating system, a postern address to the database management system.

16. The method according to claim 15, further comprising basing, by the database management system, the postern such that the data can be read or written.

17. The method according to claim 16, further comprising modifying, by the database management system the postern by calling the view instruction and providing the data expanse address, the postern address, starting offset and the size of the view.

18. The method according to claim 16, further comprising deleting, by the database management system, the postern by calling the view instruction, providing the data expanse address and a null postern address.
